(19) United States
(12) Patent Application Publication
(10) Pub. No.: US 2007/0139489 A1
(43) Pub. Date: Jun. 21, 2007

(54) Refilling device of an ink cartridge for an inkjet printer

(76) Inventor: Alex Kuo-Shen Wang, Las Vegas, NV (US)

Correspondence Address: PRO-TECHTOR INTERNATIONAL SERVICES, 20775 NORADA CT., SARATOGA, CA, 95070, US

(21) Appl. No.: 11/312,045

(22) Filed: Dec. 19, 2005

(51) Int. Cl. B41J 2/17

(52) U.S. Cl. 347/84; 347/86

(57) ABSTRACT

An ink refilling device of an ink cartridge for an inkjet printer is composed of at least one injection tube and at least one ink refiller, wherein a tube connector at one end of the injection tube can be inserted into an injection hole of an ordinary ink cartridge, and a tube connector at the other end of the injection tube can be connected to a needle tube which can be fixed at an ink outlet of a cap of the ink refiller. A siphon tube is connected at a bottom end of the ink outlet, and an air hole is located on the cap for connecting with ambient atmosphere. When refilling the ink, the ink inside the ink refiner can be filled into the ink cartridge through the injection tube and can be continuously supplied to a printer by a siphonage effect until it is used up, without having to switch off the printer and taking out the ink cartridge.

### BACKGROUND OF THE INVENTION

a) Field of the Invention

The present invention relates to a refilling device of an ink cartridge for an inkjet printer, and more particularly to a refilling device which can continuously supply ink by a siphonage effect until the ink inside an ink refiner is used up, without switching off a printer and removing out the ink cartridge, thereby having a characteristic of environmental protection.

b) Description of the Prior Art

For an ordinary ink refilling method of an inkjet printer, the printer should be switched off before taking out an ink cartridge, and then an ink refiner will be used to inject ink into the ink cartridge. As the printer should be switched off and then the ink cartridge should be taken out before refilling the ink, this conventional ink refilling method is very troublesome and is unable to supply the ink continuously. Moreover, as an interior of the ink refiner is not in contact with ambient atmosphere, the ink inside the refiner cannot be expelled completely and some residual ink will be left in the refiller, which will cause a waste and even create a severe problem of recycling to environmental protection.

### SUMMARY OF THE INVENTION

The primary object of the present invention is to provide an ink refilling device which is composed of at least one injection tube and at least one ink refiller, such that when refilling ink inside an ink cartridge, a printer will not have to be switched off and an ink cartridge will not have to taken out, to continuously supply the ink by a siphonage effect until the ink inside the ink refiner is used up, thereby having a characteristic of environmental protection.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows a perspective view of an injection tube and a needle tube of the present invention.

FIG. 3 shows a perspective view of components of an ink refiner of the present invention.

FIG. 3-1 shows a perspective view of a part of components of an ink refiner of the present invention.

FIG. 4 shows a schematic view of an action of refilling ink of the present invention.

### DETAILED DESCRIPTION OF THE PREFERRED EMBODIMENTS

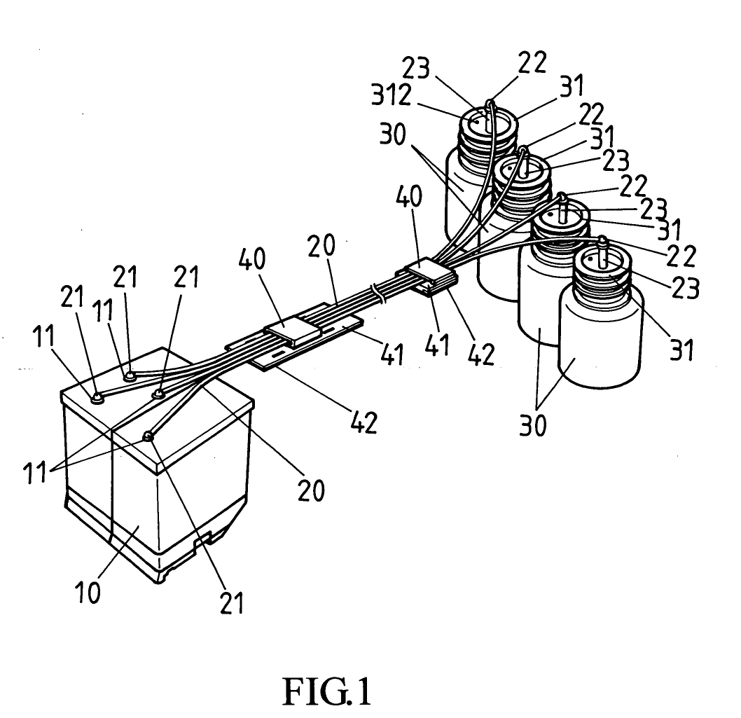

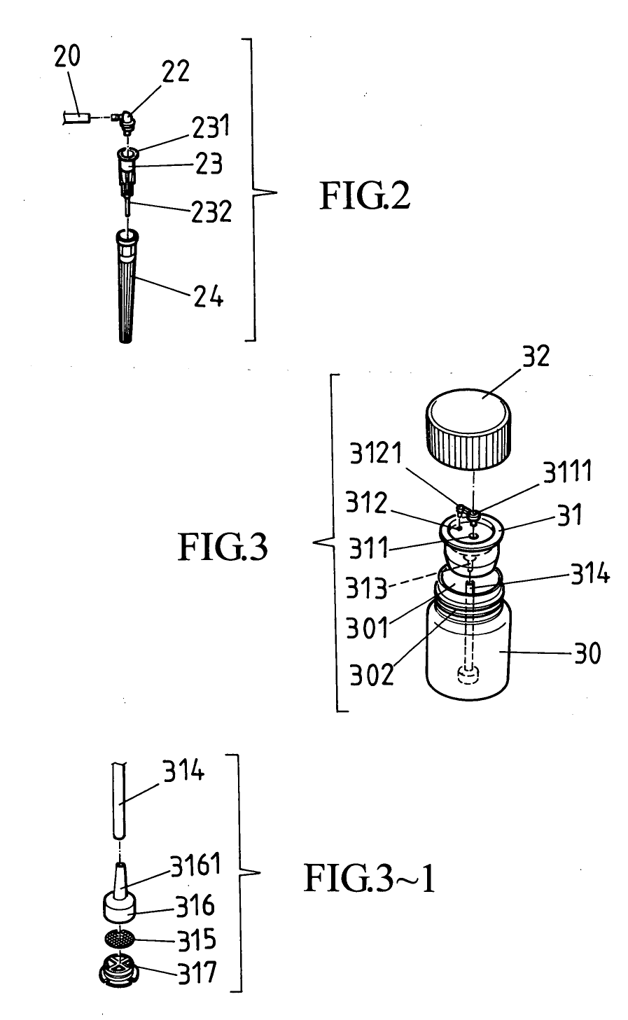

Referring to FIG. 1, an ink cartridge 10 is filled with inks of different colors and its top end is provided with a plurality of injection holes 11. A continuous ink supply device is composed of at least one injection tube 20 which is provided with a tube connector 21 at one end thereof for being inserted into the injection hole 11 of ink cartridge 10, and a tube connector 22 at the other end thereof, as shown in FIG. 2, for being connected with a needle tube 23 whose tube hole 231 at its one end can provide for an insertion of the tube connector 22, and whose other end is fixed with a needle head 232 which is prevented from pricking people by covering the needle tube 23 with a needle sheath 24 in an idle condition; and at least one ink refiner 30, as shown in FIG. 3. An opening 301 at a top end of the ink refiner 30 is fixed with a plug 31 whose top end is provided with a cap 32. The cap 32 has female screws and can be locked on male threads 302 of the ink refiner 30. An ink outlet 311 and an air hole 312 are located at a top end of the plug 31. The ink outlet 311 can provide for an insertion of the needle tube 23 at one end of the injection tube 20, and a connection tube 313 at a bottom end thereof is inserted with a siphon tube 314 which is extended into the ink refiner 30. Ink in the ink refiner 30 is expelled from the ink outlet 311 by a siphonage effect of the siphon tube 314, flowing into the injection tube 20 through the needle tube 23, and then injected into the ink cartridge 10. An interior of the ink cartridge 10 is connected with ambient atmosphere with the air hole 312 of plug 31, so as to facilitate a complete expelling of the ink inside the ink refiner 30 through the siphon tube 314. When the ink cartridge 30 is not filled with the ink, the ink outlet 311 and the air hole 312 are clogged by interconnected plugs 3111, 3121, respectively, so as to prevent the ink from flowing out. Referring to FIG. 3-1, a filtering net 315 at a bottom end of the siphon tube 314 is emplaced in a net shade 316 whose insertion tube 3161 at a top end thereof is inserted with the siphon tube 314, and whose bottom end is provided with a net cover 317 to hold the filtering net 315.

The plurality of injection tubes 20 are installed with a plurality of fixing seats 40 whose bottom plates 41 can have different lengths. The bottom plate 41 is attached to a printer for positioning with a twin adhesive 42 adhered to the bottom plate 41.

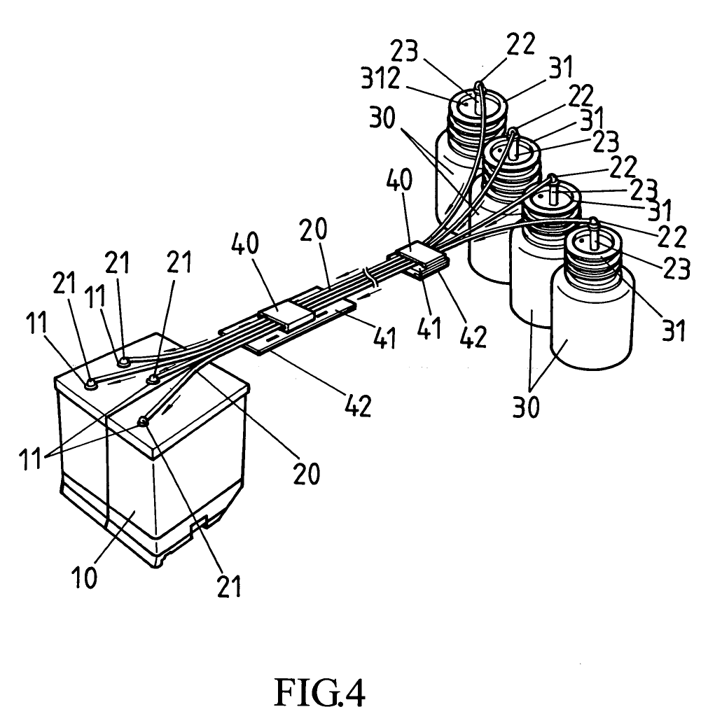

Referring to FIG. 4, the ink inside the ink refiner 30 is filled into the ink cartridge 10 through the injection tube 20 by a siphonage effect, and then supplied to a printer from an ink injection hole at a bottom of the ink cartridge 10, following the direction of arrow.

Accordingly, the ink cartridge of present invention can be filled with the ink for being used repeatedly. The most important is that the printer will not have to be switched off and the ink cartridge will not have to be taken out upon refilling the ink, and the refilling device can continuously supply the ink until the ink inside the ink refiner is used up, by the siphonage effect.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A refilling device of an ink cartridge for an inkjet printer wherein the ink cartridge is provided with an injection hole and the refilling device comprises at least one injection tube having a tube connector at one end for being inserted into the injection hole of ink cartridge, and a tube connector at the other end thereof for being connected to a needle tube which is provided with a tube hole at one end thereof for providing for an insertion of the tube connector of injection tube and whose other end for being fixed with a needle head; and at least one ink refiner whose opening at a top end thereof is fixed with a plug having an ink outlet and an air hole, with a top end of ink outlet providing for an insertion of needle tube, a bottom end of ink outlet being inserted with a siphon tube, and the air hole being connected to ambient atmosphere; the ink inside the ink refiner flowing into the ink outlet through the siphon tube and then being filled into the ink cartridge through the injection tube.

2. The refilling device of an ink cartridge for an inkjet printer according to claim 1, wherein a needle sheath is covered on the needle tube at one end of the injection tube.

3. The refilling device of an ink cartridge for an inkjet printer according to claim 1, wherein a cap is located at a top end of the plug of ink refiller and can be locked on male threads of the ink refiller.

4. The refilling device of an ink cartridge for an inkjet printer according to claim 1, wherein the ink outlet and the air hole can be connected with a plug, respectively.
